(19) United States
(12) Patent Application Publication
(10) Pub. No.: US 2003/0067937 A1
(43) Pub. Date: Apr. 10, 2003

(54) System for transmitting data between modules and method for controlling the same

(75) Inventor: Heung-soo Kim, Ansan-city (KR)

Correspondence Address: SUGHRUE MION, PLLC, 2100 Pennsylvania Avenue, NW, Washington, DC, 20037-3213, US

(73) Assignee: SAMSUNG ELECTRONICS CO., LTD.

(21) Appl. No.: 10/217,159

(22) Filed: Aug. 13, 2002

(30) Foreign Application Priority Data
Oct. 5, 2001 (KR) KPA 2001-61498

(51) Int. Cl. H04L 12/40

(52) U.S. Cl. 370/438

(57) ABSTRACT

A data transmission system for transmitting data between a plurality of modules. The data transmission system has a data bus for transmitting the data between the modules, a control signal bus for transmitting a request signal for requesting use of the data bus and an allowance signal related to allowing the use of the data bus, and a bus controller for controlling the control signal bus. The bus controller receives the request signal transmitted from the modules through the control signal bus, and transmits the allowance signal with respect to one of the modules in response to the request signal, to the modules through the control signal bus. The allowed module transmits the data through the data bus, and the request and the allowance is performed through the control signal bus while the data is being transmitted.

### BACKGROUND OF THE INVENTION

1. Field of the Invention

The present invention relates to a system for transmitting data between modules and a method for controlling the same, and more particularly, to a system for transmitting data, and a method for controlling the same, capable of improving a transmission efficiency of the data by performing a request for use of a data bus of a plurality of modules and an allowance for use of the data bus with respect to the modules, while transmitting data between the modules, by using the data bus. The present application is based on Korean Patent Application No. 2001-61498 filed on Oct. 5, 2001, which in incorporated herein by reference.

2. Description of the Related Art

For a plurality of modules performing the same functions or for a plurality of modules performing different functions to transmit data, the modules use a plurality of buses, such as a data bus for transmitting the data and a clock signal bus for transmitting a clock signal. One example of a data transmission system using a plurality of buses is introduced in U.S. Pat. No. 5,901,146 (Asynchronous Data Transfer and Source Traffic Control System).

FIG. 1 of the present application is a view showing a conventional data transmission system capable of mutual data transmission, by having a plurality of buses. In particular, FIG. 1 shows a system that is substantially the same as the system that has been introduced in the above-mentioned US patent.

As shown in FIG. 1, the conventional data transmission system comprises a plurality of buses 20 for communicating between the modules 10, and a bus controller 30 for controlling a data transmission operation through the plurality of buses 20. The buses 20 include a data bus 21 for transmitting the data communicated between the plurality of modules 10, a clock signal bus 25 used for transmitting a clock signal to synchronize a transmission timing of the data, and a frame signal bus 27 for transmitting a frame signal for indicating a partition point of a data frame that is a data transmission unit.

FIG. 2 is a view showing a structure of the data transmitted through the data bus 21 in the data transmission system shown in FIG. 1, and shows the structure of one data frame. The data transmitted during a 16 clock cycle forms one data frame, and 32 bits of data are transmitted per every pulse during the 16 clock cycle. To transmit 32 bits of data, the data bus 21 is composed of 32 parallel lines as shown in FIG. 1.

As shown in FIG. 2, a request signal is transmitted by each of the modules 10 in a 1st clock of one data frame. The data is transmitted by each of the modules 10 in a 2nd clock through a 15^{th} clock. An allowance signal is transmitted by the bus controller 30 in a 16^{th} clock.

Every 2 bits of the request signal have one corresponding module 10. Therefore, the 32 bits request signal can be used for assigning a maximum of 16 modules 10. For example, as indicated by a number at a 1st row of the data frame, a 1st module 11 corresponds to a 1st and a 2nd bit of the request signal, a 2nd module 12 corresponds to a 3rd and a 4th bit, and a nth module 19 corresponds to (2n−1)th and 2nth bit. When at least one of the 1st and the 2nd bit of the request signal is ‘1’, the bus controller 30 determines that the 1st module 11 requests for allowance of the data bus 21.

The data is composed of a bus header bit row (transmitted from the 2nd clock), a data header bit row (transmitted from the 3rd clock), and a data bit row (transmitted from the 4th clock through the 15^{th} clock). The data is transmitted by a module that receives the allowance, among all of the modules.

The bus controller transmits an allowance signal indicating a number of a module to be allowed to use the data bus 21. For example, when the value of the request signal is ‘2’, the 2nd module 12 is allowed to use the data bus 21. The bus controller 30 allows one module among the modules 10 that have transmitted the request signal, to use the data bus 21, and transmits the allowance signal corresponding to the request signal to each of the modules 10 through the data bus 21.

FIG. 3 is a view showing a transmission timing of a pulse transmitted through each of the buses 20 of FIG. 1.

A clock pulse generated by a clock generator (not shown) is transmitted to the bus controller 30 and each of the modules 10 through the clock signal bus 25. The bus controller 30 generates one frame signal whenever 16 clock signals are input. The frame signal is transmitted to each of the modules 10 through the frame signal bus 27. Accordingly, each of the modules 10 can be informed of a start point of each of the data frames.

As described before, the 1st bit row of each of the data frames is used by the module 10 for transmitting the request signal, and the last bit row of each of the data frames is used by the bus controller 30 for transmitting the allowance signal. For example, as shown in FIG. 3, when the 1st module 11 generates the request signal (R1) in the 1st clock of the 1st frame, the request signal (R1) is transmitted to the bus controller 30 through the data bus 21, and the bus controller 30 generates the allowance signal (A) with respect to the 1st module 11 in the last clock of the 1st frame in response to the transmitted request signal (R1). The allowance signal (A1) is transmitted to each of the modules 10 through the data bus 21.

The 1st module 11 among each of the modules 10 receives the allowance signal (A1), and transmits the data (D1) to each of the modules 10 through the data bus 21 in a 2nd frame following the 1st frame. Each of the modules 10 receives and stores the data (D1) in response to the content recorded in a bus header and a data header in the transmitted data (D1).

On the other hand, a 1st bit row of the 2nd frame is used by each of the modules 10 for transmitting the request signal to the bus controller 30. In addition, a last bit row of the 2nd frame is used by the bus controller 30 for transmitting again the allowance signal to each of the modules 10. For example, when the request signal (R1) of the 1st module 11 and the request signal (R2) of the 2nd module 12 are transmitted at the same time in the 2nd frame, the bus controller 30 transmits the allowance signal (A2) with respect to one module, for example, the 2nd module 12, according to a predetermined method. Therefore, the allowed 2nd module 12 can transmit the data (D2) in a following 3rd frame.

Similarly, as shown in FIG. 3, when the 1st module 11 and the 2nd module 12 respectively transmit the request signal (R1, R2) in the 3rd frame, the bus controller 30 transmits the allowance signal (A2) with respect to one of them, for example, the 2nd module 12, and the allowed 2nd module 12 transmits the data (D2) in a 4th frame. When the 1^{st} module 11 transmits the request signal (R1) again in the 4th frame, the bus controller 30 transmits the allowance signal (A1) in response to the request signal, and the 1st module 11 transmits the data (D1) in a 5th frame.

Similarly, when the request signal is transmitted from one module or a plurality of modules 10 in the 1^{st} clock of one frame, the bus controller 30 transmits the allowance signal with respect to one of the modules in the last clock of the same data frame. One of the modules 10 that has been allowed to use the data bus 21, as indicated in the last clock of the data frame right before the next data frame, transmits the data in the clock generated between the 1^{st} clock and the last clock of the next data frame.

However, since the conventional transmission system cannot transmit the data while the request signal and the allowance signal are being transmitted, data transmission efficiency is lowered. In other words, as the request signal, the data, and the allowance signal are consecutively transmitted through the data bus 21, each of the modules 20 cannot transmit the data during 2 clock cycles in a 16 clock cycle data frame, while the request signal and the allowance signal are being transmitted. Thus, the data transmission efficiency is lowered.

### SUMMARY OF THE INVENTION

The present invention has been made to overcome the above-mentioned problems. Thus, the object of the present invention is to provide a data transmission system capable of improving data transmission efficiency as a request signal and an allowance signal for the use of a data bus can be transmitted while the data is being transmitted between a plurality of modules.

The above object is accomplished by providing a data transmission system comprising: a data bus for transmitting the data between the modules; a control signal bus for transmitting a request signal for requesting use of the data bus, and an allowance signal for allowing use of the data bus; and a bus controller for receiving the request signal transmitted from at least one of the modules through the control signal bus, and transmitting the allowance signal to one of the modules through the control signal bus in response to the request signal, while the data is being transmitted through the data bus between at least two of the modules.

Preferably, the data transmission system according to the present invention comprises: a clock signal bus for transmitting a clock signal for synchronizing a transmission timing of the data and the control signal; and a frame signal bus for transmitting a frame signal indicating a partition point of a data frame along with the clock signal, the data frame being a transmission unit of the data. The request signal and the allowance signal corresponding to the request signal are respectively transmitted while the different data frames are being transmitted. Therefore, the bus controller can perform a calculation for deciding a module to be allowed to use the data bus 21 during an interval of a request signal transmission time and an allowance signal transmission time.

The allowance signal comprises a plurality of module information bits corresponding respectively to the plurality of modules. The module information bits have identification information of the modules. Thus, the plurality of modules can respectively transmit their own request signals.

Moreover, the allowance signal comprises a module number bit for transmitting the identification information of the module which has been allowed to use the data bus, and an allowance bit for informing that the use of the data bus has been allowed to the module indicated by the module number bit. Accordingly, the bus controller can transmit the allowance signal and a number of a module to be allowed to use the data bus 21, to each of the modules. Further, by doing so, an error that might occur while the allowance signal is being transmitted can be prevented.

According to the present invention, the request and the allowance with respect to the data bus is performed while the data is being transmitted. Therefore, the data transmission efficiency is improved.

On the other hand, according to the present invention, a method for controlling the data transmission is provided. The controlling method comprises the steps of: a) preparing a data bus for transmitting the data between the modules, and a control signal bus for transmitting a request signal for requesting use of the data bus and an allowance signal related to allowing use of the data bus; b) transmitting the request signal from at least one of the modules to the bus controller through the control signal bus, while the data is being transmitted through the data bus between at least two of the modules; and c) transmitting the allowance signal from the bus controller to one of the modules through the control signal bus in response to the request signal, while the data is being transmitted through the data bus between at least two of the modules.

### BRIEF DESCRIPTION OF THE DRAWINGS

The above-mentioned object and the features of the present invention will be more apparent by describing the preferred embodiment of the present invention by referring to the appended drawings, in which:

FIG. 1 is a block diagram showing a conventional data transmission system for transmitting data between a plurality of modules;

FIG. 2 is a view showing a data frame transmitted in the data transmission system of FIG. 1;

FIG. 3 is a view showing a pulse transmission timing through each bus of FIG. 1;

FIG. 4 is a block diagram showing a transmission system according to the present invention for transmitting the data between the plurality of modules;

FIG. 5 is a view showing a data frame transmitted in the data transmission system of FIG. 4;

FIG. 6 is a view showing a pulse transmission timing through each bus of FIG. 4; and

FIG. 7 is a flow chart showing a data transmission control process performed by the data transmission system of FIG. 4.

### DETAILED DESCRIPTION OF THE PREFERRED EMBODIMENTS

From now on, the present invention will be described in great detail by referring to the appended drawings.

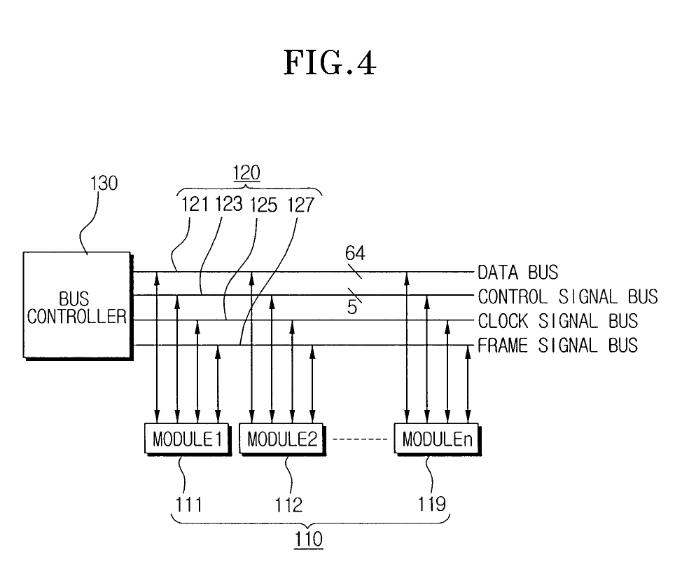

FIG. 4 is a block diagram showing a data transmission system according to the present invention for transmitting data between a plurality of modules.

As shown in FIG. 4, the data transmission system according to the present invention comprises a plurality of buses 120 for transmitting data between the modules 111 through 119, and a bus controller 130 for controlling the data transmission through the buses 120. The buses 120 are composed of a data bus 121 for transmitting the data communicated between the plurality of modules 110, a control signal bus 123 for transmitting a control signal needed for the data transmission of the modules 110, a clock signal bus 125 used for transmitting a clock signal to synchronize a transmission timing of the data, and a frame signal bus 127 for transmitting a frame signal indicating a partition point of a data frame, which is a data transmission unit.

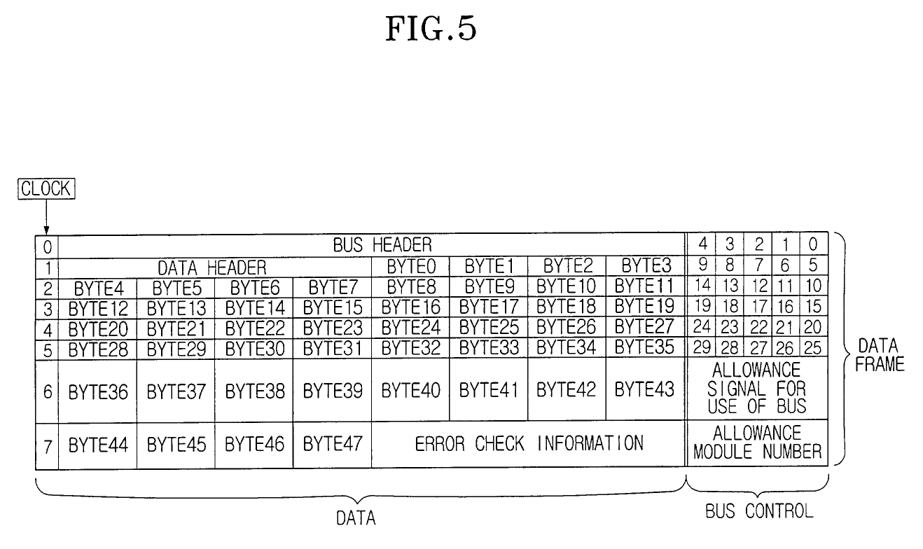

FIG. 5 is a view showing a structure of the data transmitted through the data bus 121 in the data transmission system shown in FIG. 4, and a structure of the control signal transmitted through the control signal bus 123. In the preferred embodiment of the present invention, it will be described that the data transmitted during an 8 clock cycle forms one data frame, and 64 bits of data is transmitted in every clock pulse during the 8 clock cycle. To transmit the 64 bits data, the data bus 121 is composed of 64 parallel lines as shown in FIG. 4. Furthermore, in the preferred embodiment of the present invention, it will be described that the control signal transmitted through the control signal bus 123 is composed of 5 bits. To transmit the 5 bits control signal, the control signal bus 123 is composed of 5 parallel lines as shown in FIG. 4.

As shown in FIG. 5, a 1st bit row of data existing in one data frame is a bus header, a 2nd bit row is a data header and data (0 byte to 3 bytes). Moreover, a 3rd bit row through 7th bit row is data (4 bytes to 43 bytes), and an 8th bit row is data (44 bytes to 47 bytes) and error check information. The data (0 byte to 47 bytes) is content substantially transmitted by the allowed module among the modules 110.

The control signal transmitted through the control signal bus 123 is composed of a request signal for requesting use of the data bus 121, transmitted from each of the modules 110 to the bus controller 130, and an allowance signal related to allowing use of the data bus 121, transmitted from the bus controller 130 to each of the modules 110. As shown in FIG. 5, a 1st bit row through a 6th bit row of one control signal is the request signal, and a 7th bit row and an 8th bit row is the allowance signal.

Each bit in the request signal is a module information bit having identification information with respect to each of the modules 110. Each of the module information bits correspond to each of the modules 10, respectively. For example, the number 0 of the LSB (Least Significant Bit) of a 1st bit row indicates a 1st module 111, and the number 29 of the MSB (Most Significant Bit) of a 6^{th} bit row indicates a 30^{th} module (not shown). The request signal is a signal for requesting use of the data bus 121 requested by each of the modules 110. For example, when the module information bit corresponding to the 1st module 111 and the 2nd module 112 in the request signal is ‘1’ (high), the bus controller 130 determines that the 1st module 111 and the 2nd module 112 have requested an allowance for use of the data bus 121. As described above, since each of the modules 110 correspond to each of the module information bits, the plurality of modules 110 can transmit their own request signals independently.

The allowance signal is composed of a module number bit (8^{th} bit row of the control signal) for transmitting the identification information of the module 110 allowed to use the data bus 121, and an allowance bit (7^{th} bit row of the control signal) indicating the module that is allowed to use the data bus 121, as indicated by the module number bit. When the allowance bit indicates a predetermined value, that is, for example, when at least one of the allowance bits is ‘1’, the bus controller 130 has allowed a certain module to use the data bus 121. At this time, the number of the allowed module is indicated by the module number bit. For example, when the value indicated by the module number bit is ‘2’, the 2nd module 112 is allowed to use the data bus 121. The bus controller 130 allows one of the modules 110 that transmitted the request signal, to use the data bus 121, and transmits the allowance signal in response to the request signal, to each of the modules 110 through the control signal bus 123.

As described above, error that might occur when the allowance signal is transmitted by the bus controller 130 can be prevented, since the allowance is transmitted together with the number of one of the modules 110 to be allowed. In other words, even when the module number bit indicates a certain module due to an error in the transmission although there is no module to be allowed by the bus controller 130, the modules 110 can be informed of the allowance of use of the data bus 121 by the certain module, by referring to the value of the allowance bit.

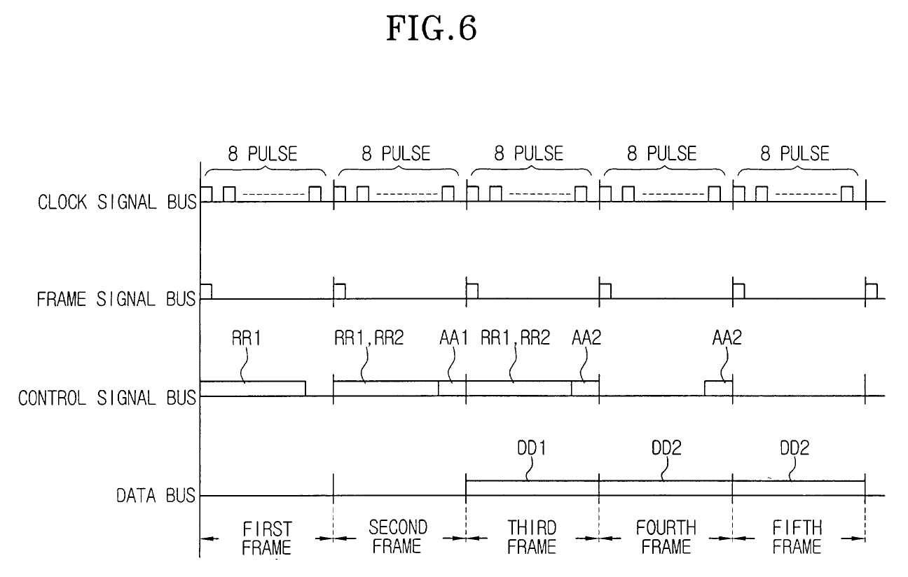

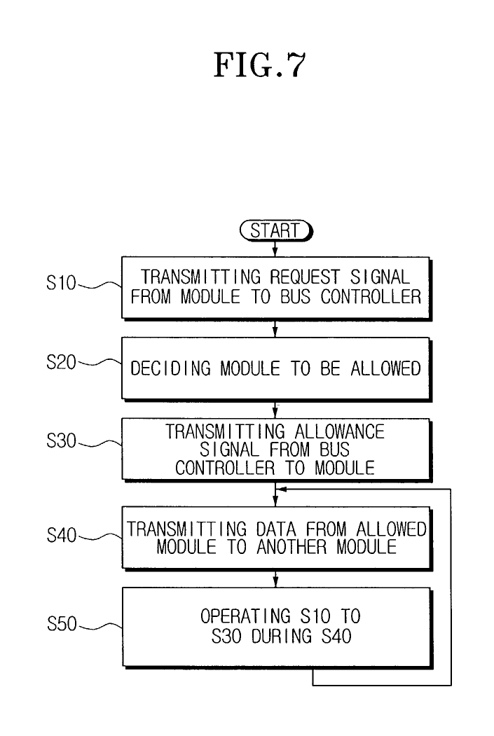

FIG. 6 is a view showing pulse transmission timing through each of the buses 120 of FIG. 4. FIG. 7 is a flow chart showing a data transmission control process performed by the data transmission system of FIG. 4.

A clock pulse generated by a clock generator (not shown) is transmitted to the bus controller 130 and each of the modules 110, through the clock signal bus 125. The bus controller 130 generates one frame signal whenever 8 clock signals are input. Therefore, the frame signal indicates the partition point of each of the data frames. The frame signal is transmitted to each of the modules 110 through the frame signal bus 127, and accordingly, each of the modules 110 can be informed of a start point of each of the data frames.

As described before, the 1st bit row to the 6^{th} bit row among the control signals transmitted through the control signal bus 123, are used by the module 110 for transmitting the request signal, and the 7^{th} bit row and the 8^{th} bit row are used by the bus controller 130 for transmitting the allowance signal. For example, as shown in FIG. 6, when the 1st module 111 generates the request signal (RR1) in the 1st clock through the 6^{th} clock, in other words, the 1st module 111 generates the ‘High’ pulse in the LSB of the 1st bit row, the request signal (RR1) is transmitted to the bus controller 130 through the control signal bus 123 (S110).

The bus controller 130 decides which module will be allowed to use the data bus 121 according to a predetermined method, in response to the transmitted request signal (RR1) (S20). At this time, the method for deciding the module to be allowed to use the bus controller 130 can be done in various ways. For example, when the request signal is transmitted from one module, then only that one module is allowed to use the data bus 121. When request signals are transmitted from a plurality of modules at the same time, the modules can be allowed to use the data bus 121 in accordance with a predetermined order. The bus controller 130 performs a calculation for deciding a module to be allowed to use the data bus 121 during the time from the 7^{th} clock of the 1st frame to the 6^{th} clock of the 2nd frame.

The bus controller 130 generates the allowance signal (AA1) with respect to the 1st module 111 in the 7^{th} clock and the 8^{th} clock of the 2nd frame in response to the transmitted request signal (RR1). The allowance signal (AA1) is transmitted to each of the modules 110 through the control signal bus 123 (S 30).

The 1st module 111 among each of the modules 110 receives the allowance signal (AA1) with respect to the 1st module 111, and transmits the data (DD1) to each of the modules 110 through the data bus 121 in the 3rd frame following the 2nd frame (S 40). Each of the modules 110 receives the data (DD1) in response to the content recorded in the bus header and the data header in the transmitted data (DD1) and stores the data (DD1).

In the meantime, while the data is being transmitted through the data bus 121 in the 3rd frame as the request and the allowance is performed, as described above, the request signal transmission step (S 10) through the allowance signal transmission step (S 30) are performed at the control signal bus 123 in the 3rd frame (S 50). The detailed description is as follows.

The 1st bit row through the 6^{th} bit row of the 2nd frame are used by each of the modules 110 to transmit the request signal again to the bus controller 130, and the 7th bit row and the 8^{th} bit row of the 2nd frame are used by the bus controller 130 to transmit the allowance signal again with respect to each of the modules 110. For example, when the request signal (RR1) of the 1st module 111 and the request signal (RR2) of the 2nd module 112 are transmitted at the same time in the 2nd frame, the bus controller 130 transmits the allowance signal (AA2) in the 7^{th} clock and the 8^{th} clock of the 3rd frame with respect to one of the modules 111, 112, such as the ₂^{nd} module 112, according to the predetermined method as described before. Similarly, when the 1st module 111 and the 2nd module 112 respectively transmit the request signals (RR1, RR2) in the 3rd frame, the bus controller 130 transmits the allowance signal (AA2) with respect to one of the modules 111, 112, such as the 2nd module 112, in the 4th frame. The allowed 2nd module 112 transmits the data (DD2) in the 5th frame.

Similarly, when the request signal is transmitted from one or a plurality of modules 110 in the 1st data frame, the bus controller 130 transmits the allowance signal with respect to one of the modules 110 in the 2nd data frame. Then, the allowed module transmits the data in the 3rd data frame.

The method described in the above is repeated in all data frames, thus the request and the allowance is transmitted through the control signal bus 123 and the module allowed in the previous data frame transmits the data. Accordingly, the data transmission through the data bus 121 can be performed without having to pause for the request or the allowance.

According to the present invention, while the data is being transmitted between the modules 110 through the data bus 121, a request signal for the use of the data bus 121 requested by the modules 110 and the allowance signal related to allowing the use of the data bus 121 sent to the modules 110, are transmitted through the control signal bus 123. Therefore, the data transmission efficiency is improved.

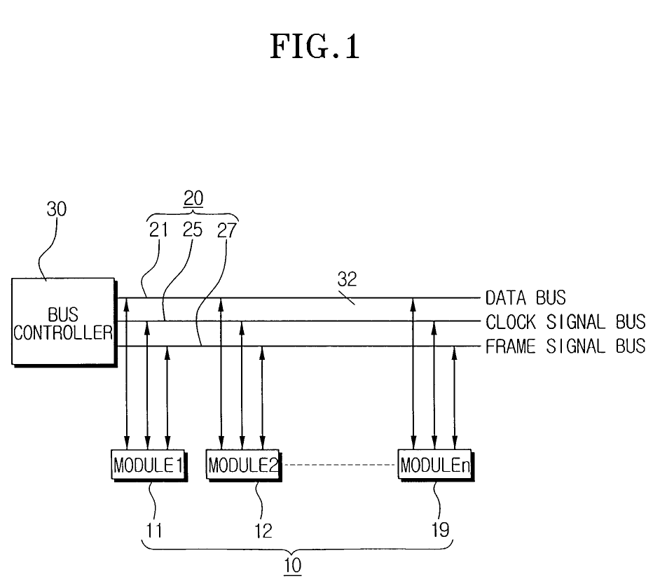

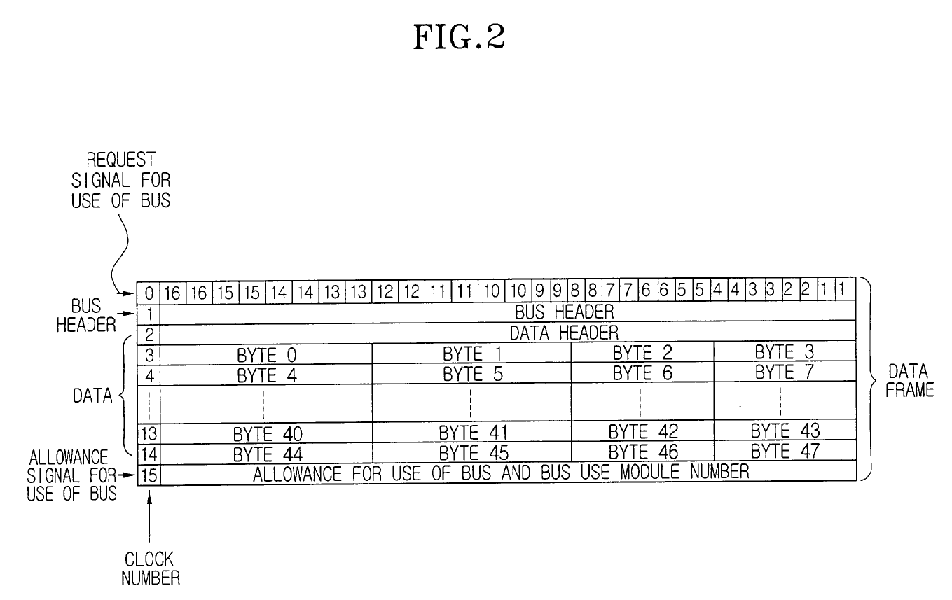

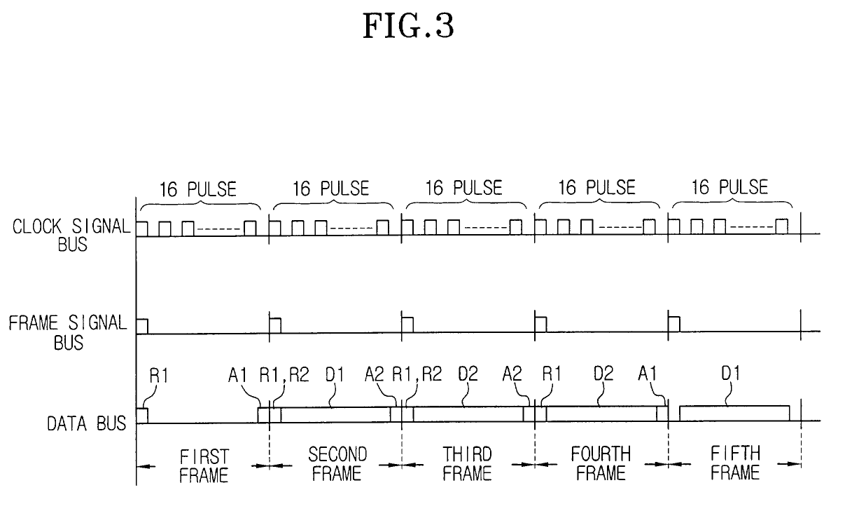

The following is the calculated result of the improved data transmission efficiency. In other words, according to the conventional data transmission system shown in FIGS. 1 to 3, since the data cannot be transmitted in the 1st clock and the 16^{th} clock during the 16 clock data frame, the data cannot be transmitted for the time of 12.5% of the entire clock cycle. Yet, according to the present invention, the data can be transmitted during the entire clock cycle, thus the data transmission efficiency can be improved 12.5%.

In the present invention, since 5 bits of data to be transmitted are added to 64 bits of data for every clock, to transmit the control signal with respect to the modules 110, the data to be transmitted is increased 7.8%, but the data transmission efficiency is improved 12.5%. Moreover, when the number of modules controlled by one control bus 130 is few, the control signal can be composed of lesser number of bits, for example, 3 bits. In this case, the amount of the data to be transmitted is reduced and the data transmission efficiency is increased.

So far, the preferred embodiment of the present invention has been illustrated and described. However, the present invention is not limited to the preferred embodiment described here, and someone skilled in the art can modify the present invention without distorting the point of the present invention, as recited in the following claims.

What is claimed is:

1. A data communication system for transmitting data between a plurality of modules, comprising:
a data bus for transmitting the data between the plurality of modules;
a control signal bus for transmitting a request signal for requesting use of the data bus, and an allowance signal related to allowing the use of the data bus; and
a bus controller for receiving the request signal transmitted from at least one of the plurality of modules through the control signal bus, and transmitting the allowance signal to one of the plurality of modules through the control signal bus in response to the request signal, while the data is being transmitted through the data bus between at least two of the plurality of modules.

2. The data communication system of claim 1, further comprising:
a clock signal bus for transmitting a clock signal for synchronizing a transmission timing of the data and a control signal; and
a frame signal bus for transmitting a frame signal indicating a partition point of a data frame along with the clock signal, the data frame being a transmission unit of the data,
wherein the request signal and the allowance signal corresponding to the request signal are transmitted while different data frames are being transmitted.

3. The data communication system of claim 2, wherein the allowance signal comprises a plurality of module information bits corresponding to the plurality of modules, respectively, each of the module information bits having identification information of each of the plurality of modules, respectively.

4. The data communication system of claim 2, wherein the allowance signal comprises:
a module number bit for transmitting identification information of said one of the plurality of modules which has been allowed to use the data bus; and
an allowance bit for indicating that the use of the data bus has been allowed to said one of the plurality of modules indicated by the module number bit.

5. A method for controlling data communication between a plurality of modules, comprising the steps of:
preparing a data bus for transmitting data between the plurality of modules, and a control signal bus for transmitting a request signal for requesting use of the data bus and an allowance signal related to allowing the use of the data bus;
transmitting the request signal from at least one of the plurality of modules to a bus controller through the control signal bus, while the data is being transmitted through the data bus between at least two of the plurality of modules; and
transmitting the allowance signal from the bus controller to one of said at least one of the plurality of modules through the control signal bus in response to the request signal, while the data is being transmitted through the data bus between said at least two of the plurality of modules.

6. The method for controlling data communication of claim 5, wherein the request signal and the allowance signal corresponding thereto are transmitted while different data frames are being transmitted.
